(19) United States
(12) Patent Application Publication
(10) Pub. No.: US 2015/0076295 A1
(43) Pub. Date: Mar. 19, 2015

(54) SUPPORT STAND FOR VIDEO-PHOTOGRAPHIC ACCESSORIES

(71) Applicant: LINO MANFROTTO + CO. S.p.A., CASSOLA (VI) (IT)

(72) Inventor: Michele FIORESE, NOVE (VI) (IT)

(21) Appl. No.: 14/487,409

(22) Filed: Sep. 16, 2014

(30) Foreign Application Priority Data
Sep. 16, 2013 (IT) PD2013A000250

(51) Int. Cl. G03B 17/56; F16M 11/38; F16M 11/28

(52) U.S. Cl. CPC G03B 17/561; F16M 11/28; F16M 11/38
USPC 248/161

(57) ABSTRACT

A telescopic support stand (1) comprises a telescopic column (2) extending along a longitudinal axis (X) and a supporting base (10) provided with a sleeve (15) intended to receive a base portion (3a) of the column (2) along which there is defined an opening bordered by an edge (15a) through which the column (2) is inserted into and extracted from the sleeve (15), the column (2) being provided with a coupling device (30) which can be moved between a coupling configuration (W) in which the column (2) is coupled with the sleeve (15) and a release configuration (W′) in which the column (2) is released from the sleeve (15), the coupling device (30) comprising an abutment element (31) which can move radially within the column (2) between the coupling configuration (W) in which an end portion (40) of the abutment element (31) projects radially from the column (2) and the release configuration (W′) in which the abutment element (31) is withdrawn towards the interior of the column (2), the end portion (40) and the edge (15a) being arranged so as to interact when the column (2) is inserted into the sleeve (15) and forms a guide and a counter device to move the abutment element (31) into the release configuration (W′).

### CROSS REFERENCE TO RELATED APPLICATION

This application claims priority to Italian patent application PD2013A000250 filed on Sep. 16, 2013, the contents of which are incorporated herein by reference.

### TECHNICAL FIELD

This invention relates to a support stand used to support video-photographic equipment and video-photographic accessories, having the characteristics stated in the pre-characterising clause of the principal claim.

Preferably the support stand according to the invention is of the telescopic column type.

### TECHNOLOGICAL BACKGROUND

The stand according to this invention has preferred but not exclusive application in the sector of video-photographic recording, in particular in the events sector, where the need to support various types of video-photographic equipment and/or accessories is known.

It is for example necessary to support lighting or sound equipment on supports which can be adjusted for height, but can easily be transported from one place to another in a folded configuration as compactly as possible, and which can easily be deployed in the desired position.

It is also required that column stands provide an effective and stable support on the ground and also that the overall dimensions during the stage in which the stands are transported and stored is as small as possible.

For this purpose stands are provided with a plurality of supporting legs, normally three, hinged to a column so that they can be unfolded from the column when in use in such a way as to form suitable supporting elements for the stand and when necessary can be folded back onto the column itself to reduce the overall dimensions of the stand.

For this purpose each leg comprises two arms hinged respectively to a collar and a sleeve which in use are both located externally to the column.

The sleeve is shaped in such a way as to receive the column and support it, and is normally fixed to the base thereof, while the collar can slide along the column in order to be moved between a position close to the sleeve in which the legs are extended from the column in such a way as to support it, and a distal position in which the legs are folded back on the column.

The collar is provided with a screw locking device to tighten/release the collar onto/from the column to prevent/allow movement of the collar along the column and lock the stand in the desired open or closed configuration.

In some versions provision is made for attaching/releasing the sleeve to/from the column in such a way that the column can be separated from the supporting legs for example to use the supporting legs to support various columns, to use the single column as a “giraffe” microphone holder, holding it with the two arms in an almost horizontal position, or to further reduce the weight and dimensions of the stand while it is being transported.

In this case the sleeve is provided with a screw coupling device which can be operated to lock/release the sleeve on/from the column in order to secure the column to the sleeve, or conversely, to allow relative movement between the sleeve and column.

Although convenient the screw locking system has a number of defects, in particular it requires a particular length of time in order to lock/release the column and sleeve.

The operation of locking/releasing the column is quite long and is particularly inconvenient for the operator, particularly because, as mentioned, it is necessary to support the weight of the column.

Therefore the operations of separating the legs from the column and vice versa of inserting the column in the sleeve and locking the column in the sleeve can be particularly laborious, especially when the column and equipment is heavy and when conversion from one working configuration to the other needs to be quick.

### SUMMARY

The problem underlying this invention is that of providing a column stand structurally and functionally designed to overcome the abovementioned limits with reference to the cited known art.

In particular, one object of the invention is to provide a column stand in which the operations of attaching/releasing the column to and from the supporting base are quicker and simpler and are also safe for the operators.

This problem is resolved through this invention by a column stand as described herein.

The foregoing has outlined rather broadly the features and technical advantages of the present invention so that the detailed description of the invention that follows may be better understood. Additional features and advantages of the invention will be described herein, which form the subject of the claims. It should be appreciated by those skilled in the art that any conception and specific embodiment disclosed herein may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that any description, figure, example, etc. herein is provided for the purpose of illustration and description only and is by no means intended to define the limits the invention.

### BRIEF DESCRIPTION OF THE DRAWINGS

Characteristics and advantages of the invention will be more apparent from the detailed description of a preferred embodiment illustrated by way of indication and without limitation with reference to the appended drawings, in which:

FIG. 1 is a partial cross-sectional view of a column stand constructed according to this invention,

FIG. 2 is a magnified view of a detail in FIG. 1,

FIG. 3 is a diagrammatical view of the detail in FIG. 2 in a second operating configuration,

FIG. 4 is a partial perspective view of the stand in FIG. 1;

FIG. 5 is a view from above of a supporting base for the stand in FIG. 1,

FIG. 6 is a view from above of a detail of the supporting base in FIG. 5,

FIG. 7 is a cross-sectional view along the plane VII-VII in FIG. 6.

### DETAILED DESCRIPTION

Additional aspects, advantages and/or other features of example embodiments will become apparent in view of the following detailed description, taken in conjunction with the accompanying drawings. It should be apparent to those skilled in the art that the described embodiments provided herein are merely exemplary and illustrative and are not limiting. Numerous embodiments of modifications thereof are contemplated as falling within the scope of this disclosure and equivalents thereto.

Any references mentioned in this specification are indicative of the level of those skilled in the art to which the invention pertains. Any references herein are incorporated by reference to the same extent as if each was specifically and individually indicated as having been incorporated by reference in its entirety.

Unless otherwise noted, technical terms are used according to conventional usage.

As used herein, “a” or “an” may mean one or more. Also as used herein in the claim(s), when used in conjunction with the word “comprising”, the words “a” or “an” may mean one or more than one. As used herein “another” may mean at least a second or more. Furthermore, unless otherwise required by context, singular terms include pluralities and plural terms include the singular.

In the figures, 1 indicates as a whole a column support stand constructed in accordance with this invention.

Stand 1 comprises a telescopic column 2 formed of a plurality of portions of tube placed within an adjacent tube in such a way that they can move with respect to each other along a longitudinal axis X of column 2, and a supporting base 10 to provide a stable support for stand 1 on the ground, as will be more particularly described below.

The portion of tube comprises an outer portion 3, an inner portion 4 and a plurality of intermediate portions 5, the number of which will be selected on the basis of specific construction requirements and/or the height which has to be reached by stand 1. Similarly the length of individual portions 3-5 will be selected on the basis of the overall height which has to be reached by stand 1.

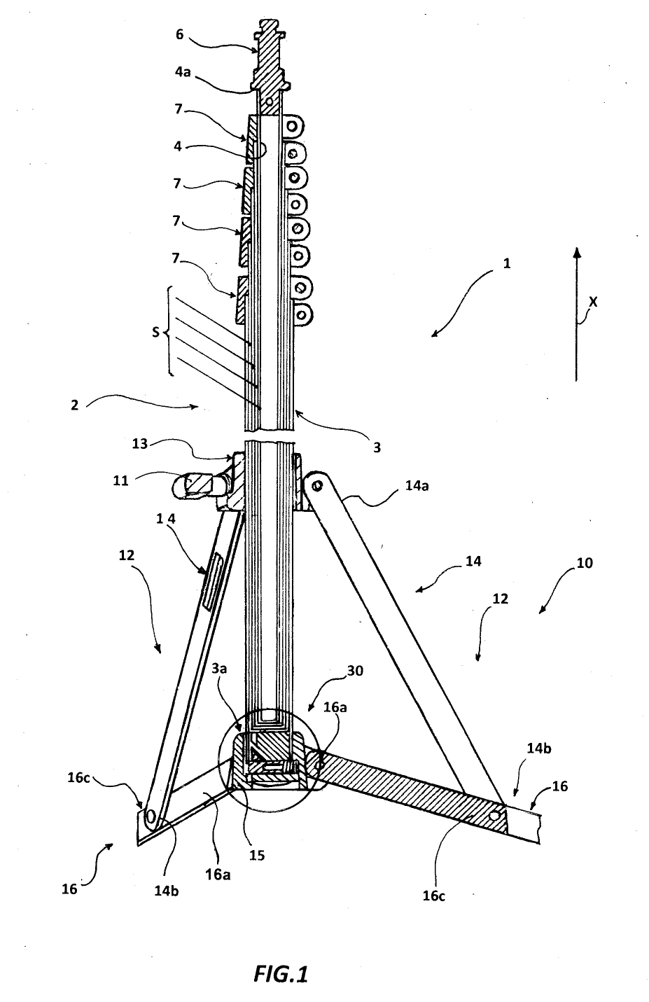

Portions 3-5 may be extracted from each other in such a way as to allow stand 1 to pass from a retracted configuration in which each tube portion is substantially housed within all of the adjacent portion, as shown in FIG. 1, and an extended configuration in which the tube portions are largely drawn out from the adjacent portion.

Internal portion 4 is provided at its free edge 4a, with an attachment member 6 for an item of video-photographic equipment or an accessory which has to be supported by stand 1 according to the invention.

Video-photographic equipment or video-photographic accessories such as for example lighting equipment or sound equipment or other equipment can be supported using the stand according to the invention, as previously stated.

Each portion 3-5 is also provided with a stop member 7 to limit the travel of each portion 3-5 with respect to the adjacent portion in which it is housed, and to lock portion 3-5 in any desired position in relation to the adjacent portions.

Also outer portion 3 is provided on a base portion 3a which when in use is designed to be placed on the ground, that is on the part opposite to the attachment member 6 for the equipment which has to be supported, with a coupling device 30 to couple outer portion 3 and therefore column 2 to supporting base 10, as will be more particularly described below.

Base portion 3a, which when in use is intended to be inserted in supporting base 10, is bounded by a free edge 3b and forms the base of column 2.

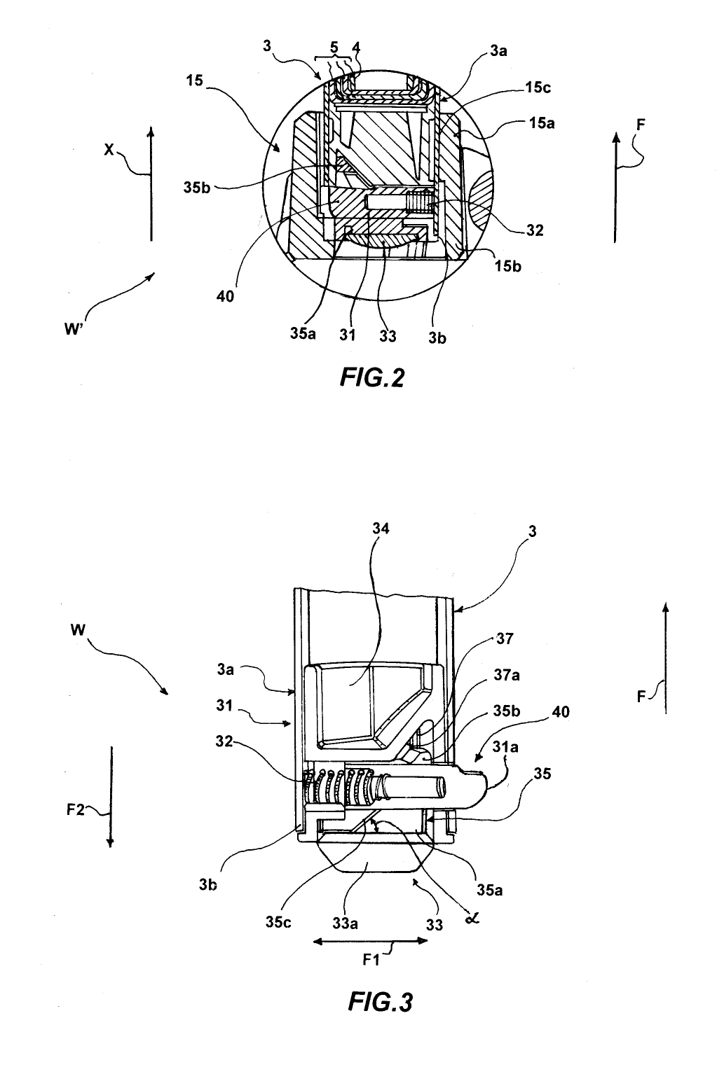

Coupling device 30 can be adjusted between a coupling configuration W illustrated in FIG. 3, in which coupling device 30 acts together with supporting base 10, to couple column 2 to supporting base 10 when column 2 is inserted into supporting base 10, and a release configuration W′ illustrated in FIGS. 1 and 2 in which coupling device 30 does not interact with sleeve 15 and column 2 is released from supporting base 10. In this configuration column 2 and supporting base 10 can be moved with respect to each other and even separated, as will be more particularly described below.

Supporting base 10 comprises a collar 13 which is intended to house outer portion 3, a sleeve 15 into which column 2 is inserted, and three supporting legs all indicated by 12, which are intended to support stand 1.

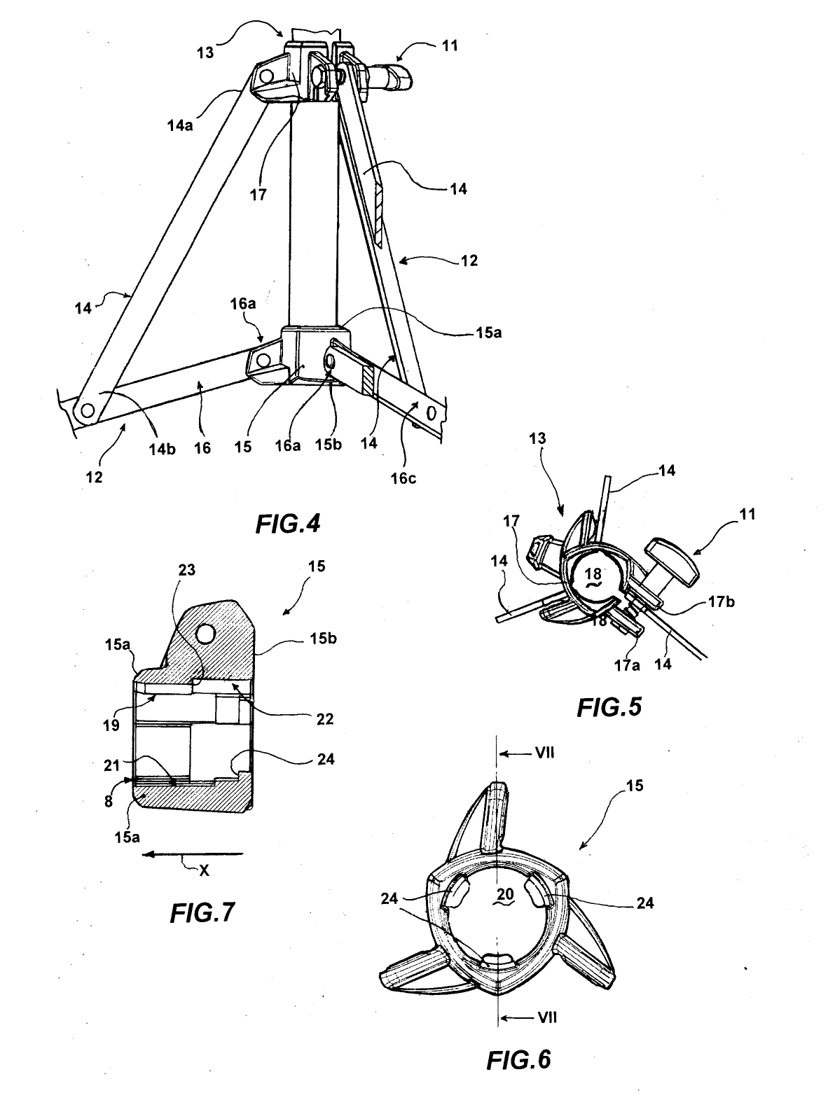

Supporting legs 12 are hinged to collar 13 and sleeve 15 respectively in such a way that they can move between an extended position illustrated in FIGS. 1 and 4, in which legs 12 are at a distance from column 2 and positioned in such a way as to impart the necessary stability to stand 1, and a folded position which is useful for transport and storage, not shown, in which legs 12 lie along column 2 in such a way as to reduce the overall dimensions of stand 1.

Collar 13 can slide along the longitudinal axis X of column 2 so as to vary the configuration of supporting legs 12.

Each supporting leg 12 comprises a first arm 14 hinged at a first end 14a thereof to collar 13 and hinged at the opposite end 14b to an intermediate portion 16c of a second arm 16 of leg 12.

Second arm 16, which is only partly shown in the figures, is hinged at a first end 16a thereof to sleeve 15 and is provided at the opposite end, not shown, with supporting feet, also not shown in the figures, intended to improve the stability of stand 1 on the ground.

Second arm 16 may be telescopic to further increase the stability of stand 1.

Supporting base 10 also comprises a locking device 11 on collar 13, to lock/release collar 13 onto/from outer portion 3 to prevent/allow relative movement collar 13 and outer portion 3, and to lock outer portion 3 and supporting base 10 in the desired working configuration.

Collar 13 comprises an annular member 17 to which first ends 14a of first arms 14 of legs 12 are hinged, and is shaped in such a way as to form a housing cavity 18 for housing the column 2, the cross-section of which may be varied through locking device 11 in such a way as to lock/release collar 13 on/from column 2.

In the version illustrated, annular member 17 is in the shape of an open ring in which opposite ends 17a, 17b are associated with a locking device, in the version illustrated a screw locking device 11, through operating which the opposite ends 17a, 17b of annular member 17 may be moved apart/together to vary the size of housing cavity 18 to allow/prevent relative movement between collar 13 and column 2.

When the opposite ends 17a, 17b of annular member 17 are at a distance from each other, collar 13 can slide on column 2 in the direction of longitudinal axis X. In this way, the first end 14a of first arm 14 is moved along outer portion 3 and the conformation of legs 12 of supporting base 10 is consequently changed.

Conversely, when the opposing ends 17a, 17b of annular member 17 are brought together, collar 13 is located in a desired position on column 2 and legs 12 are locked in a corresponding desired configuration.

Sleeve 15 of supporting base 10 has a generically open cylindrical shape at the longitudinally opposite ends, and extends between a first edge 15a, which in use faces collar 13 and defines an opening 8 through which column 2 is inserted in sleeve 15 and removed therefrom, and a second opposite edge 15b which in use faces the ground.

Sleeve 15 is also shaped in such a way that its inner surface 19 defines a housing cavity 20 housing column 2 comprising in the direction of longitudinal axis X a first cavity portion 21 provided by the part of base sleeve 15 which when in use faces collar 13, and a second cavity portion 22 provided by the part of base sleeve 15 which when in use faces the ground, which has a larger cross-section than first cavity portion 21.

In a longitudinally intermediate position between the first and second cavity portions 21, 22 there is also provided a stop member 23, in the version illustrated shaped as a projection projecting from inner surface 19 towards receiving cavity 20.

First cavity portion 21 is therefore defined between first edge 15a and stop member 23, the second cavity portion 22 is defined between stop member 23 and second edge 15b.

Second cavity portion 22 is dimensioned in such a way as to house column 2 with coupling device 30 in coupling position W to couple the column to supporting base 10, as will be more particularly described below, while first cavity portion 21 is on the contrary dimensioned in such a way as to house column 2 with coupling device 30 in release position W′. Stop member 23 abuts against coupling device 30 of outer portion 3 to prevent movement of column 2 with respect to sleeve 15 in the direction indicated by arrow F in FIGS. 2 and 3, as will be more particularly described below.

Three supporting teeth 24, provided in second cavity portion 22 and projecting from internal surface 19 into second cavity portion 22 and providing the supporting members for column 2 when the latter 2 is inserted into sleeve 15, are also provided on the inner surface 19 of base sleeve 15.

Supporting teeth 24 are provided in a longitudinally intermediate position between stop member 23 and edge 15b of the sleeve which when in use faces the ground.

Teeth 24 are arranged circumferentially apart on inner surface 19, preferably but not necessarily equally spaced. In other versions which are not shown a number of supporting teeth other than three for example four, may be provided.

Coupling device 30 of the column 2 comprises an abutting element 31, formed in this embodiment by an abutting tooth which can move radially in column 2 in both the directions of arrow F1 in FIG. 3 between the coupling configuration W illustrated in FIG. 3, in which an end portion 40 of abutting tooth 31 projects radially from column 2, and release configuration W′ illustrated in FIGS. 1 and 2, in which abutting tooth 31 is retracted within column 2.

End portion 40 of abutting tooth 31 is capable of interacting with first edge 15a of sleeve 15 when column 2 is inserted in sleeve 15.

End portion 40 comprises a curved wall 31a, facing first edge 15a when column 2 is inserted in sleeve 15, and this is shaped in such a way as to move with respect to first edge 15a when column 2 is inserted in sleeve 15, to progressively push abutting tooth 31 from coupling position W to release position W′.

In a version not shown wall 31a may be inclined in such a way as to slide with respect to first edge 15a when column 2 is inserted in sleeve 15.

In the portion facing abutting tooth 31, first edge 15a may be provided with an inclined or curved wall in such a way as to encourage the sliding of abutting tooth 31 when column 2 is inserted into sleeve 15 to progressively push abutting tooth 31 from coupling position W to release position W′.

The provision of at least one inclined or curved wall between the mutually facing walls of end portion 40 and first edge 15a makes it possible to guide the movement of abutting tooth 31 from coupling position W to release position W′, when column 2 is inserted in sleeve 15.

The mutually facing walls of end portion 40 and first edge 15a therefore form a guide and a counter device to guide the movement of abutment tooth 31 from coupling position W to release position W′ when column 2 is inserted in sleeve 15.

When column 2 is inserted into sleeve 15, in coupling configuration W, abutting tooth 31 abuts against inner surface 19 of sleeve 15 coupling column 2 to sleeve 15, while in release configuration W′ abutting tooth 31 is moved away from inner surface 19 of sleeve 15 and the column can be moved with respect to sleeve 15.

Coupling device 30 also comprises a thrust element associated with abutting tooth 31, arranged so as to push abutting tooth 31 so that it projects outward from column 2, or with end portion 40 which projects radially with respect to column 2.

In the version illustrated the thrust element comprises a spring 32, which is loaded to push abutting tooth 31 into coupling configuration W.

Through the force of spring 32, when column 2 is inserted in supporting base 10, abutting tooth 31 is therefore pushed to abut against inner surface 19 of sleeve 15, as will be more particularly described below.

Coupling device 30 also comprises an actuating element 33 which can be moved in the direction of longitudinal axis X of column 2 to cause radial movement of abutting tooth 31 against the force of spring 32, as more particularly described below.

By acting on actuating element 33 it is possible to move abutting tooth 31 from coupling configuration W to release configuration W′, as more particularly described below.

In the version shown, actuating element 33 comprises an actuating pushbutton 33a, provided on the free edge 3b of outer portion 3 and can be moved in the direction of arrow F in FIG. 3 to move abutting tooth 31 from coupling configuration W to release configuration W′.

Actuating pushbutton 33a comprises a moving member projecting from free edge 3b towards the interior of outer portion 3 and shaped in the form of a wedge 35 whose base 35a is fixed to actuating pushbutton 33a and the tip 35b of which projects within outer portion 3. Wedge 35 is arranged in such a way that its radial dimension increases progressively towards actuating pushbutton 33a.

Between base 35a and tip 35b, wedge 35 is provided with an inclined surface 35c which is intended to slide on a corresponding inclined surface, not shown in the figures, provided on abutting tooth 31 when actuating pushbutton 33a is moved between coupling configuration W and release configuration W′.

Inclined surface 35c of wedge 35 and the inclined surface of abutting tooth 31 form a slide and counter device capable of aiding and guiding movement of actuating pushbutton 33a and abutting tooth 31 in coupling device 30.

When actuating pushbutton 33a is pushed in the direction of arrow F, that is placed in release configuration W′, wedge 35 is likewise pushed towards the interior of column 2, the dimension of inclined surface 35c in the radial direction corresponding to abutting tooth 31 increases, and inclined surface 35c exerts a force opposite to the force exerted by spring 32 on the corresponding inclined surface of abutting tooth 31 such as to progressively push abutting tooth 31 towards the interior of column 2.

When coupling device 30 is moved between coupling configuration W and release configuration W′ and vice versa, the inclined surfaces of wedge 35 and abutting tooth 31 slide over each other in such a way as to guide the movement of coupling device 30.

As mentioned, this sliding causes radial movement of abutting tooth 31 towards the interior of column 2 respectively, or conversely towards the exterior of the same.

Inclined surface 35c of wedge 35 and the inclined surface of abutting tooth 31 are inclined with respect to the longitudinal axis by an angle a which is preferably between 15° and 75°, and preferably between 40° and 50°.

The provision of inclined surfaces makes it possible to improve the relative movement between wedge 35 and abutting tooth 31 or the action of actuating element 33a.

The provision of inclined surfaces makes it possible to aid the movement of coupling device 30 between coupling configuration W and release configuration W′, or to assist the release of column 2 by the user.

Coupling device 30 also comprises a supporting element 34 provided within outer portion 3 and shaped in such a way as to form a sliding cavity 37 in a position opposite wedge 35, shaped in such a way as to receive and couple with the shape of wedge 35.

When actuating pushbutton 33a is in release configuration W′, wedge 35 is substantially inserted within sliding cavity 37, the corresponding facing surfaces abut against each other and abutting tooth 31 is inserted within column2 and the latter can be moved in the direction of arrow F to be slid out of base sleeve 15.

When actuating pushbutton 33a is in coupling configuration W, wedge 35 is partly inserted within sliding cavity 37, the corresponding facing surfaces being at a distance from each other and end portion 40 of abutting tooth 31 projects radially with respect to column 2 and abuts against inner surface 19 of sleeve 15 when column 2 is inserted in sleeve 15. In this configuration column 2 is locked on supporting base 10.

When no force is exerted on actuating pushbutton 33a by the user, spring 32, acting on abutting tooth 31, moves the latter outside column 2 and operating pushbutton 33 in the direction of arrow F2, that is it places the coupling device in coupling configuration W.

This makes it possible for column 2 to be automatically coupled to supporting base 10, increasing the safety of stand 1, as will be more particularly described below.

Conversely, in order to release column 2 from supporting base 10 it is necessary to act on coupling device 30, exerting a force in the direction of arrow F on actuating pushbutton 33 so as to overcome the force of spring 32 in order to bring it into release configuration W′.

Column 2 is therefore prevented from being inadvertently released from base 10.

Actuating pushbutton 33 is provided on a suitable position on column 2 so that it can be accessible to the user and at the same time undesired operation of actuating pushbutton 33 are prevented.

In the version illustrated actuating pushbutton 33 is located on the free edge 3b of outer portion 3 in such a way that it can be positioned in the vicinity of sleeve 15 facing the ground when column 2 is inserted in support 10.

Thanks to the conformation of supporting legs 12, actuating pushbutton 33 is raised off the ground and is therefore accessible to the user, but is not exposed to any accidental impacts while stand 1 is in use.

Sleeve 15 of supporting base 10 is normally made of plastics material or aluminium, and is produced by moulding.

In order to manufacture supporting teeth 24 during the pressing stage, channels which are not shown in the figures are made in inner surface 19 of sleeve 15. The width of abutting tooth 31 must be greater than the width of the channels in order to prevent column 2 from undesirably sliding from sleeve 15.

In a version of stand 1, which is not shown, the coupling device is provided on the sleeve of the supporting base and is intended to couple the portion of the column with supporting base 10.

Again in this case the coupling device can be moved between a coupling configuration in which the coupling device acts together with the column to couple the column with the supporting base when the column is inserted in the supporting base, and a release configuration in which the coupling device does not interact with the column.

The coupling device may comprise an abutment element which in this case may also be formed by an abutment tooth which can move radially within the sleeve, such that in the coupling configuration an end portion of the abutment tooth projects radially within the sleeve to abut against the column, while in the release configuration the abutment tooth is positioned in the sleeve in such a way that it does not interact with the column. In this version the outer surface of the column is provided in its base portion with a cavity to receive the abutment tooth in the coupling configuration and a stop member able to abut against the abutment tooth to prevent movement of the column with respect to the sleeve in the direction of the longitudinal axis.

Again in this case at least one inclined or curved wall is provided between the mutually facing walls of the end portion and the first edge of the sleeve to guide movement of the abutment tooth from the coupling position to the release position when the column is inserted into the sleeve.

Again in this version the coupling device further comprises a thrust element associated with the abutting tooth, arranged so as to push the abutment tooth so that it projects within the sleeve.

Again in this version provision is made for an actuating element for the coupling device associated with the sleeve which can be moved to cause radial movement of the abutting tooth against the action of the thrust, that is from the coupling configuration to the release configuration.

In order to use stand 1 the user inserts column 2 into supporting base 10 with coupling device 30 in coupling position W, that is with the end portion 40 of abutting t tooth 31 projecting radially with respect to column 2, that is first in collar 13 and then in sleeve 15.

When column 2 is inserted into sleeve 15 in the direction indicated by arrow F2, end portion 40 or its curved wall 31a abuts against first edge 15a of sleeve 15.

Progressive pushing of column 2 in the direction of arrow F2 causes relative movement between first edge 15a of sleeve 15 and the curved wall of the end portion, which progressively pushes abutting tooth 31 towards the interior of column 2 and finally into release configuration W′.

Curved wall 31a is shaped to assist the movement of abutting tooth 31 within column 2.

As insertion of column 2 into base sleeve 15 continues, abutment tooth 31 is first moved to the position of cavity portion 21 and then overcomes stop member 23 and is therefore moved to second cavity portion 22, which, as mentioned, has a larger cross-section than first cavity portion 21.

When column 2 is supported on supporting teeth 24, abutting tooth 31 is positioned relative to second cavity portion 22 and may project radially with respect to column 2, through the force of spring 32, so that end portion 40 abuts against second cavity portion 22. Because column 2 is supported on supporting teeth 24 coupling device 30 is moved into coupling configuration W by spring 32 without any further action being required on the part of the user.

In this position stop member 23 prevents movement of column 2 in the direction indicated by arrow F; movement in the opposite direction being prevented by supporting teeth 24, and column 2 is stably coupled with supporting base 10.

In the case where it is desired to release supporting base 10 from column 2, it is necessary to act on actuating pushbutton 33a after having moved upper sleeve 13 away, pushing the button in the direction of arrow F, moving it into release position W′ in such a way as to progressively insert wedge 35 into sliding cavity 37.

After this movement wedge 35 moves over the surface of abutting tooth 31. The inclined surface of wedge 35 moving on the corresponding inclined surface of abutting tooth 31 progressively moves abutting tooth 31 within column 2, progressively moving it away from inner surface 19 of sleeve 15.

By holding actuating pushbutton 33a in release position W′ it is possible to move column 2 in the direction of arrow F, extracting it from sleeve 15.

Moving column 2 in the direction of arrow F, after stop member 23 has been overcome, or when abutting tooth 31 is in the location of first cavity portion 21, it is possible to release actuating pushbutton 33a and to continue to slide column 2 because the conformation of first cavity portion 21 prevents coupling device 30 from adopting coupling configuration W, despite the thrust of spring 32.

When the column is extracted from sleeve 15, spring 32 pushes the end portion of abutment tooth 31 to project radially with respect to column 2.

The provision of actuating pushbutton 33 assists the release of column 2.

This invention thus overcomes the above mentioned problem described with reference to the cited known art.

Although the invention has been described in example embodiments, those skilled in the art will appreciate that various modifications may be made without departing from the spirit and scope of the invention. It is therefore to be understood that the inventions herein may be practiced other than as specifically described. Thus, the present embodiments should be considered in all respects as illustrative and not restrictive. Accordingly, it is intended that such modifications fall within the scope of the present invention as defined by the claims appended hereto.

1. A telescopic support stand comprising
a telescopic column extending along a longitudinal axis (X) and
a support base which has a sleeve intended to receive a base portion of said column and in which is formed an opening delimited by an edge through which said column is inserted into and extracted from said sleeve, said column having a coupling device which can be moved between a coupling configuration (W) in which said column is coupled to said sleeve and a release configuration (W′) in which said column is uncoupled from said sleeve, wherein said coupling device comprises an abutment element which is movable radially in said column between said coupling configuration (W), in which an end portion of said abutment element projects radially from said column, and said release configuration (W′), in which said abutment element is retracted towards the interior of said column, said end portion and said edge being designed to interact during the insertion of said column into said sleeve and to form a guide and a counter device for moving said abutment element into said release configuration (W′).

2. The stand according to claim 1, wherein at least one of said end portion and said edge has a wall, located in a position facing the other of said edge and said end portion, which is inclined relative to said longitudinal axis (X) and which is shaped so as to slide relative to said edge or, conversely, relative to said end portion, in order to move said abutment element progressively into said release configuration (W′).

3. The stand according to claim 1, wherein at least one of said end portion and said edge has a wall, located in a position facing the other of said edge and said end portion, which is curved relative to said longitudinal axis (X) and which is shaped so as to slide relative to said edge or, conversely, relative to said end portion, in order to move said abutment element progressively into said release configuration (W′).

4. The stand according to claim 1, wherein said coupling device comprises a pusher element operatively associated with said abutment element and intended to push said abutment element from said release configuration (W′) to said coupling configuration (W).

5. The stand according to claim 4, wherein said pusher element comprises a spring loaded so as to push said abutment element from said release configuration (W′) to said coupling configuration (W).

6. The stand according to claim 1, wherein said coupling device further comprises an actuating element which can be moved along said longitudinal axis (X) of said column so as to push said abutment element from said coupling configuration (W) to said release configuration (W′).

7. The stand according to claim 1, wherein said coupling device comprises a slide and a counter device adapted to facilitate and guide the movement of said coupling device from said coupling configuration (W) to said release configuration (W′) and vice versa.

8. The stand according to claim 7, wherein said slide comprises a wedge having a base associated with said actuating element and an inclined surface intended to slide, in the movement from said coupling configuration (W) to said release configuration (W′) and vice versa, on a corresponding inclined surface of said abutment element so as to guide the radial movement of said abutment element.

9. The stand according to claim 8, wherein said inclined surface and said corresponding inclined surface of said abutment element are inclined relative to said longitudinal axis (X) at an angle a.

10. The stand according to claim 9, further comprising a support element, associated with said column and shaped so as to delimit, in a position facing said wedge, a sliding cavity shaped so as to receive in a shape coupling said wedge when said coupling device is in said release configuration (W′).

11. The stand according to claim 9, wherein said angle a is in the range from 40° to 50°.

12. The stand according to claim 1, wherein said support base comprises a plurality of support legs which are hinged, respectively, on a collar, which is slidable along said longitudinal axis (X) of said column, and on said sleeve of said stand, said collar being provided with a locking device to tighten or slacken said collar on said column to allow or prevent the sliding of said collar and said column relative to each other.
